(19) United States
(12) Patent Application Publication
(10) Pub. No.: US 2007/0114760 A1
(43) Pub. Date: May 24, 2007

(54) Trailer hitch guide

(76) Inventor: Raymond L. Hegefeld, Kaufman County, TX (US)

Correspondence Address: W. THOMAS TIMMONS, 1320 PRUDENTIAL DRIVE, SUITE 208, DALLAS, TX, 75235-4117, US

(21) Appl. No.: 11/546,721

(22) Filed: Oct. 12, 2006

Related U.S. Application Data
(60) Provisional application No. 60/725,787, filed on Oct. 12, 2005.

(51) Int. Cl. B60D 1/36

(52) U.S. Cl. 280/477

(57) ABSTRACT

A trailer hitch guide is shown for attaching to a ball mount on a towing vehicle includes an alignment guide centered between the ball mount and the towing vehicle and a ball mount engaging member affixed to the alignment guide opposite the towing vehicle. The ball mount engaging member forms a hole for receiving the bolt of the ball. In a preferred arrangement of the trailer hitch guide includes downwardly directed members affixed to the sides of the ball mount engaging member, for restricting movement of the ball mount engaging member with respect to the ball mount. The thickness of the alignment guide and the thickness of the ball mount engaging member are at least one fourth inch. In another arrangement, the wings form angles of from about 25 degrees to about 35 degrees with respect to the sides. In yet another arrangement, the alignment guide comprises a back, two sides extending at angles of approximately 45 degrees from the edges of the back and two wings extending in curving arcs out from the edges of the two sides opposite the edges attached to the back. The wings form angles of approximately 30 degrees with respect to the sides.

### (b) CROSS-REFERENCE TO RELATED APPLICATIONS

This application is a Continuation-in-Part of Provisional Application No. 60/725,787, filed Oct. 12, 2005.

Applicant is also applicant for and sole owner of application Ser. No. 11/225,455 entitled “Trailer Hitch Guide.”

### (c) STATEMENT REGARDING FEDERALLY SPONSORED RESEARCH OR DEVELOPMENT

Not Applicable

### (d) INCORPORATION-BY-REFERENCE OF MATERIAL SUBMITTED ON A COMPACT DISC

Not Applicable

### (e) BACKGROUND OF THE INVENTION

1. Field of the Invention

This invention relates generally to trailer hitches and in particular to guides for aligning towed vehicles to towing vehicles.

2. Description of Related Art

Guides for aligning trailer hitch ball sockets with hitch balls on towing vehicles are well know. Many are designed for step style bumpers. Others are designed to be removable so that they will not be damaged or limit turning ability.

### (f) BRIEF SUMMARY OF THE INVENTION

A trailer hitch guide according to the present invention for attaching to a ball mount on a towing vehicle includes an alignment guide centered between the ball mount and the towing vehicle and a ball mount engaging member affixed to the alignment guide opposite the towing vehicle, wherein the ball mount engaging member forms a hole for receiving the bolt of the ball. In one arrangement, the alignment guide includes a back, two sides extending at angles of from about 40 degrees to about 50 degrees from the edges of the back and two wings extending in curving arcs out from the edges of the two sides opposite the edges attached to the back. The two side are of equal length and the width of the back is greater than half the length of either side and the length of the two wings are equal and greater than half the length of the two sides.

A preferred arrangement of the trailer hitch guide includes downwardly directed members affixed to the sides of the ball mount engaging member, for restricting movement of the ball mount engaging member with respect to the ball mount. The thickness of the alignment guide and the thickness of the ball mount engaging member are at least one fourth inch.

In another arrangement, the wings form angles of from about 25 degrees to about 35 degrees with respect to the sides.

In yet another arrangement, the alignment guide includes a back, two sides extending at angles of approximately 45 degrees from the edges of the back and two wings extending in curving arcs out from the edges of the two sides opposite the edges attached to the back. The wings form angles of approximately 30 degrees with respect to the sides.

These and other objects, advantages and features of this invention will be apparent from the following description taken with reference to the accompanying drawing, wherein is shown a preferred embodiment of the invention.

### (g) BRIEF DESCRIPTION OF THE SEVERAL VIEWS OF THE DRAWING

FIG. 1 is a top view of an alignment guide according to the present invention;

FIG. 2 is a left front view of the ball mount engaging member of FIG. 1;

FIG. 3 is a front view of the trailer hitch guide of FIG. 1;

FIG. 4 is a top view of an alignment guide according to the present invention;

FIG. 5 is a left front view of the ball mount engaging member of FIG. 4;

FIG. 6 is a front view of the trailer hitch guide of FIG. 4;

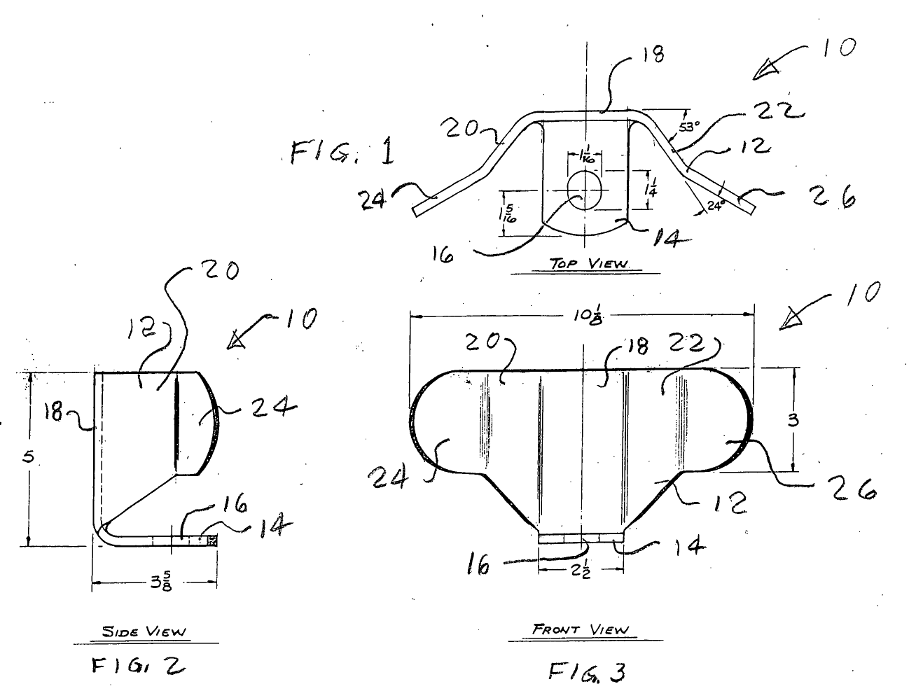

### (h) DETAILED DESCRIPTION OF THE INVENTION

A trailer hitch guide according to the present invention if referred to generally by reference numeral 10. Trailer hitch guide 10 is for attaching to a ball mount on a towing vehicle. It includes an alignment guide 12 centered between the ball mount and the towing vehicle and a ball mount engaging member 14 affixed to the alignment guide opposite the towing vehicle. The ball mount engaging member forms a hole 16 for receiving the bolt of the ball. In one arrangement, the alignment guide includes a back 18, two sides 20 and 22 extending at angles of from about 40 degrees to about 50 degrees from the edges of the back and two wings 24 and 26 extending in curving arcs out from the edges of the two sides opposite the edges attached to the back. The two side are of equal length and the width of the back is greater than half the length of either side and the length of the two wings are equal and greater than half the length of the two sides.

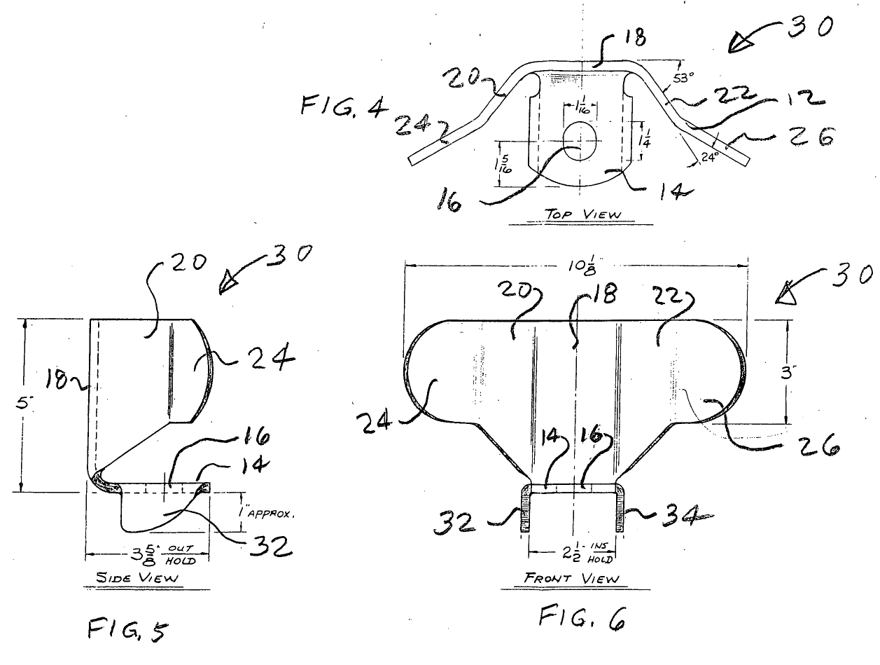

Referring now to FIGS. 4, 5 and 6, an alternative embodiment of a trailer hitch guide according to the present invention is referred to generally by reference numeral 30, where like parts are given the same reference numerals. a preferred arrangement of the trailer hitch guide includes downwardly directed members 32 and 34 affixed to the sides of the ball mount engaging member, for restricting movement of ball mount engaging member 14 with respect to the ball mount. The thickness of the alignment guide and the thickness of the ball mount engaging member are at least one fourth inch.

In another arrangement, the wings form angles of from about 25 degrees to about 35 degrees with respect to the sides.

In yet another arrangement, the alignment guide includes a back, two sides extending at angles of approximately 45 degrees from the edges of the back and two wings extending in curving arcs out from the edges of the two sides opposite the edges attached to the back. The wings form angles of approximately 30 degrees with respect to the sides.

From the foregoing it will be seen that this invention is well adapted to attain all of the ends and objectives hereinabove set forth, together with other advantages which are inherent to the apparatus.

It will be understood that certain features and subcombinations are of utility and may be employed without reference to other features and subcombinations. This is contemplated by and is within the scope of the claims.

As many possible embodiments may be made of the invention without departing from the scope thereof, it is to be understood that all matter herein set forth or shown in the figures of the accompanying drawings is to be interpreted as illustrative and not in a limiting sense.

1. A trailer hitch guide for attaching to a ball mount on a towing vehicle comprising in combination:
an alignment guide centered between the ball mount and the towing vehicle; and
a ball mount engaging member affixed to the alignment guide opposite the towing vehicle, wherein the ball mount engaging member forms a hole for receiving the bolt of the ball;

2. A trailer hitch guide according to claim 1, wherein the alignment guide comprises a back, two sides extending at angles of from about 40 degrees to about 50 degrees from the edges of the back and two wings extending in curving arcs out from the edges of the two sides opposite the edges attached to the back.

3. A trailer hitch guide according to claim 2, wherein the two side are of equal length and the width of the back is greater than half the length of either side and the length of the two wings are equal and greater than half the length of the two sides.

4. A trailer hitch guide according to claim 3, further comprising downwardly directed members affixed to the sides of the ball mount engaging member, for restricting movement of the ball mount engaging member with respect to the ball mount.

5. A trailer hitch guide according to claim 4, wherein the thickness of the alignment guide and the thickness of the ball mount engaging member are at least one fourth inch.

6. A trailer hitch guide according to claim 2, wherein the wings form angles of from about 25 degrees to about 35 degrees with respect to the sides.

7. A trailer hitch guide according to claim 6, wherein the two side are of equal length and the width of the back is greater than half the length of either side and the length of the two wings are equal and greater than half the length of the two sides.

8. A trailer hitch guide according to claim 7, further comprising downwardly directed members affixed to the sides of the ball mount engaging member, for restricting movement of the ball mount engaging member with respect to the ball mount.

9. A trailer hitch guide according to claim 8, wherein the thickness of the alignment guide and the thickness of the ball mount engaging member are at least one fourth inch.

10. A trailer hitch guide according to claim 1, wherein the alignment guide comprises a back, two sides extending at angles of approximately 45 degrees from the edges of the back and two wings extending in curving arcs out from the edges of the two sides opposite the edges attached to the back.

11. A trailer hitch guide according to claim 10, wherein the two side are of equal length and the width of the back is greater than half the length of either side and the length of the two wings are equal and greater than half the length of the two sides.

12. A trailer hitch guide according to claim 11, further comprising downwardly directed members affixed to the sides of the ball mount engaging member, for restricting movement of the ball mount engaging member with respect to the ball mount.

13. A trailer hitch guide according to claim 12, wherein the thickness of the alignment guide and the thickness of the ball mount engaging member are at least one fourth inch.

14. A trailer hitch guide according to Claim 10, wherein the wings form angles of approximately 30 degrees with respect to the sides.

15. A trailer hitch guide according to claim 14, wherein the two side are of equal length and the width of the back is greater than half the length of either side and the length of the two wings are equal and greater than half the length of the two sides.

16. A trailer hitch guide according to claim 15, further comprising downwardly directed members affixed to the sides of the ball mount engaging member, for restricting movement of the ball mount engaging member with respect to the ball mount.

17. A trailer hitch guide according to claim 16, wherein the thickness of the alignment guide and the thickness of the ball mount engaging member are at least one fourth inch.
